(19) United States
(12) Patent Application Publication
(10) Pub. No.: US 2025/0148635 A1
(43) Pub. Date: May 8, 2025

(54) INFORMATION PROCESSING APPARATUS, INFORMATION PROCESSING METHOD, AND COMPUTER-READABLE RECORDING MEDIUM

(71) Applicant: NEC Corporation, Tokyo (JP)

(72) Inventor: Gaku NAKANO, Tokyo (JP)

(73) Assignee: NEC Corporation, Tokyo (JP)

(21) Appl. No.: 18/911,774

(22) Filed: Oct. 10, 2024

(30) Foreign Application Priority Data
Nov. 2, 2023 (JP) 2023-188378

(51) Int. Cl. G06T 7/60; G06T 7/13; G06V 10/764; G06V 10/776

(52) U.S. Cl. CPC G06T 7/60; G06T 7/13; G06V 10/764; G06V 10/776; G06T 2207/20076

(57) ABSTRACT

An information processing apparatus including: an estimating unit configured to estimate, using sample points extracted from a plurality of data points, tentative geometric parameters that fit the sample points; an error calculating unit configured to calculate errors between the plurality of data points and the tentative geometric parameters; a threshold value determining unit configured to calculate a boundary value for classifying a logarithmic space of the calculated errors into two or more classes, and determine a threshold value by transforming the calculated boundary value; and an updating unit configured to count a number of inliers for which the calculated errors are less than or equal to the calculated threshold value, and when the number of inliers counted increases, update current best geometric parameters and a current best number of inliers with the tentative geometric parameters and the number of inliers, respectively.

### CROSS-REFERENCE TO RELATED APPLICATION

This application is based upon and claims the benefit of priority from Japanese patent applications No. 2023-188378, filed on Nov. 2, 2023, the disclosure of which is incorporated herein in its entirety by reference.

### BACKGROUND OF THE INVENTION

### 1. Field of the Invention

The present disclosure relates to an information processing apparatus, an information processing method, and a computer-readable recording medium for estimating geometric parameters.

### 2. Background Art

A technique for estimating geometric parameters that fit a plurality of data points is used in fields such as statistics, signal processing, and computer vision, for example. The geometric parameters indicate a straight line, an ellipse, a plane, a spherical surface, a hyperplane, or the like. The geometric parameters in the computer vision are a camera position and projective transformation, for example.

Incidentally, data points include observation noise, in general. In such a case, it is known that an estimation least squares method in which the probability distribution of the observation noise is assumed to be a normal distribution with the expected value being zero is statistically optimal (or maximum likelihood estimation) as a method for estimating geometric parameters from a plurality of data points. “Statistically optimal” means that an error (or distance) that occurs between a plurality of data points and calculated geometric parameters is minimal under a normal distribution.

When the probability distribution of observation noise is assumed to be a Laplace distribution, it is known that the minimum absolute value method is maximum likelihood estimation as a method of estimating geometric parameters from data points. Moreover, when the probability distribution is unknown, it is known that the geometric parameters are estimated from data points using a normal distribution following an experimental rule that many of natural phenomena are in normal distributions.

Here, when the geometric parameters are estimated from data points, the data points that follow a probability distribution that is assumed in advance are referred to as inliers, and the data points that do not follow the probability distribution are referred to as outliers.

The outliers are generated due to a singular individual, an observation limit of a measurement device, and the like. When an image is captured by a camera, for example, pixel values are discretized, and therefore values that are more than or less than a sampling limit may become singular values.

If there is at least one such outlier that does not follow a normal distribution in the data points, the fitting accuracy of geometric parameters with respect to many inliers by a least squares method decreases, because the least squares method estimates geometric parameters that fit the outlier.

As a related technique, in Non-Patent Document 1 (M. A. Fischler and R. C. Bolles, “Random Sample Consensus: A Paradigm for Model Fitting with Applications to Image Analysis and Automated Cartography” [online], July 1981, Communications of the ACM (Association for Computing Machinery), vol. 24, no. 6, pp. 381-395, 1981. [retrieved on Oct. 23, 2023], Internet <URL: https://doi.org/10.1145/358669.358692>), M-estimation and RANSAC (Random Sample Consensus) are disclosed as a method of estimating geometric parameters at high accuracy while removing outliers. The M-estimation is also referred to as a weighted least squares method, in which weighting is performed such that as the error of a data point increases, the contribution ratio decreases, and parameters are estimated.

As a related technique, in Patent Document 1 (Japanese Patent No. 6954346), M-estimation in which the threshold value of a weight function is automatically adjusted is disclosed. However, stable convergence of the M-estimation greatly depends on initial values of parameters. Therefore, depending on the initial values, removal of outliers is not sufficient, and convergence to inaccurate parameters may occur.

In RANSAC, parameters are estimated by extracting minimum number of samples needed for parameter estimation from input data points at random, and errors with respect to all data points are calculated. Then, the numbers of inliers and outliers are counted, in which data points whose errors are smaller than a pre-determined threshold value are inliers, and data points whose errors are larger than the threshold value are outliers. After repeating the aforementioned random sampling and error calculation a fixed number of times, the parameters with which the number of inliers is largest are determined as best values.

As a related technique, in Patent Document 2 (Japanese Patent No. 6571225), a method of estimating the relative position and orientation of a camera from two images is disclosed as a usage example of RANSAC.

As a related technique as well, in Non-Patent Document 2 (O. Chum, J. Matas, and J. Kittler, “Locally optimized RANSAC”, [online, September 2003, Pattern Recognition: 25th DAGM Symposium, Magdeburg, Germany, Sep. 10-12, 2003. Proceedings 25. Springer Berlin Heidelberg, 2003. [retrieved on Oct. 23, 2023] Internet <URL: https://doi.org/10.1007/978-3-540-45243-0_31>, LO-RANSAC is disclosed in which convergence of RANSAC is stabilized by executing a least squares method using tentative inliers halfway through repetition.

However, in RANSAC, the actual inlier probability distribution in unknown, and therefore it is difficult to determine an appropriate threshold value in advance.

Specifically, if the threshold value is not appropriate, inliers and outliers are mistakenly determined, and the estimation accuracy of geometric parameters decreases. An empirical value is also used as the threshold value in many times, in general. For example, when straight line fitting on an image is performed, a straight line is determined such that the distances between points and the straight line, which are geometric distances, are less than or equal to three pixels.

In actuality, however, when the image resolution is high, one pixel may be appropriate, and when a point error is large, five pixels may be appropriate. The unit of error may also be not necessarily intuitive, such as a pixel value. For example, when the parameter desired to be obtained is a hyperplane, a dimensionless scale referred to as an algebraic distance is used. Because the algebraic distance is not a scale indicating an actual distance, different from image pixels, it is difficult to empirically and intuitively determine the threshold value in advance.

### SUMMARY OF THE INVENTION

### Problems to be Solved by the Invention

An example object of the present disclosure is to determine a threshold value for separating between outliers and inliers in RANSAC.

In order to achieve the example object described above, an information processing apparatus according to an example aspect of the present disclosure includes:
an estimating unit configured to estimate, using sample points extracted from a plurality of data points, tentative geometric parameters that fit the sample points;
an error calculating unit configured to calculate errors between the plurality of data points and the tentative geometric parameters;
a threshold value determining unit configured to calculate a boundary value for classifying a logarithmic space of the calculated errors into two or more classes, and determine a threshold value by transforming the calculated boundary value; and
an updating unit configured to count a number of inliers for which the calculated errors are less than or equal to the calculated threshold value, and when the number of inliers counted increases, update current best geometric parameters and a current best number of inliers with the tentative geometric parameters and the number of inliers, respectively.

Also, in order to achieve the example object described above, an information processing method according to an example aspect of the present disclosure includes:
estimating, using sample points extracted from a plurality of data points, tentative geometric parameters that fit the sample points;
calculating errors between the plurality of data points and the tentative geometric parameters;
calculating a boundary value for classifying a logarithmic space of the calculated errors into two or more classes, and determining a threshold value by transforming the calculated boundary value; and
counting a number of inliers for which the calculated errors are less than or equal to the calculated threshold value, and when the number of inliers counted increases, updating current best geometric parameters and a current best number of inliers with the tentative geometric parameters and the number of inliers, respectively.

Furthermore, in order to achieve the example object described above, a computer-readable recording medium according to an example aspect includes a program recorded on the computer-readable recording medium, the program including instructions that cause the computer to carry out:
estimating, using sample points extracted from a plurality of data points, tentative geometric parameters that fit the sample points;
calculating errors between the plurality of data points and the tentative geometric parameters;
calculating a boundary value for classifying a logarithmic space of the calculated errors into two or more classes, and determining a threshold value by transforming the calculated boundary value; and
counting a number of inliers for which the calculated errors are less than or equal to the calculated threshold value, and when the number of inliers counted increases, updating current best geometric parameters and a current best number of inliers with the tentative geometric parameters and the number of inliers, respectively.

As described above, according to the present disclosure, it is possible to determine a threshold value for separating between outliers and inliers in RANSAC.

### BRIEF DESCRIPTION OF THE DRAWINGS

FIG. 1 is a diagram for describing an example of the information processing apparatus.

FIG. 2 is a diagram for describing an example of a system including the information processing apparatus.

FIG. 3 is a diagram for describing an example of the operations of the information processing apparatus.

FIG. 4 is a diagram for describing the effects.

FIG. 5 is a diagram for describing an example of a computer that realizes the information processing apparatus in the example embodiment and the modifications.

### EXEMPLARY EMBODIMENT

Hereinafter, an example embodiment will be described with reference to the drawings. Note that, in the drawings described below, the elements that have the same or corresponding functions are given the same reference numerals and description thereof may not be repeated.

### Example Embodiment

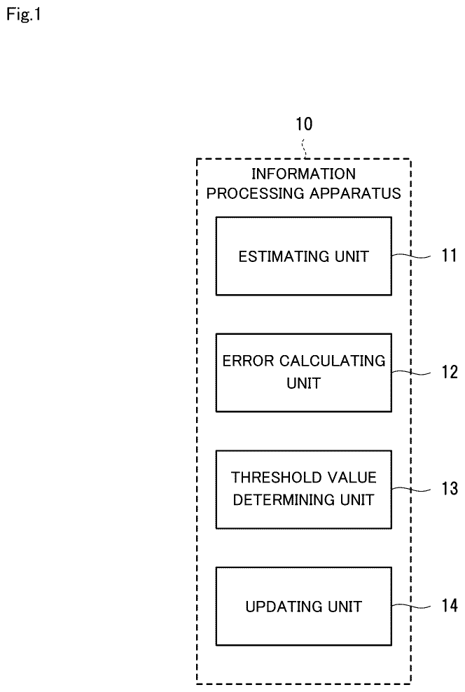

The configuration of an information processing apparatus in the example embodiment will be described using FIG. 1. FIG. 1 is a diagram for describing an example of the information processing apparatus.

### [Apparatus Configuration]

The information processing apparatus 10 shown in FIG. 1 is an apparatus that calculates a threshold value for separating points corresponding to a plurality of pieces of data between inliers and outliers, and estimates geometric parameters that fit the inliers (geometric parameter estimation apparatus). The information processing apparatus 10 shown in FIG. 1 includes an estimating unit 11, an error calculating unit 12, a threshold value determining unit 13, and an updating unit 14.

The estimating unit 11 estimates, using sample points extracted from a plurality of data points, tentative geometric parameters that fit the sample points. The error calculating unit 12 calculates errors between the plurality of data points and the tentative geometric parameters. The threshold value determining unit 13 calculates a boundary value for classifying a logarithmic space of the calculated errors into two or more classes, and determines the threshold value by transforming the boundary value. The updating unit 14 counts the number of inliers whose errors are less than or equal to the threshold value, and when the number of counted inliers increases, updates current best geometric parameters and a current best number of inliers with the tentative geometric parameters and the number of inliers, respectively.

As described above, in the example embodiment, the current best geometric parameters and the current best number of inliers are updated with the tentative geometric parameters and the number of counted inliers, and therefore it is possible to determine the threshold value for classifying between outliers and inliers in RANSAC.

### [System Configuration]

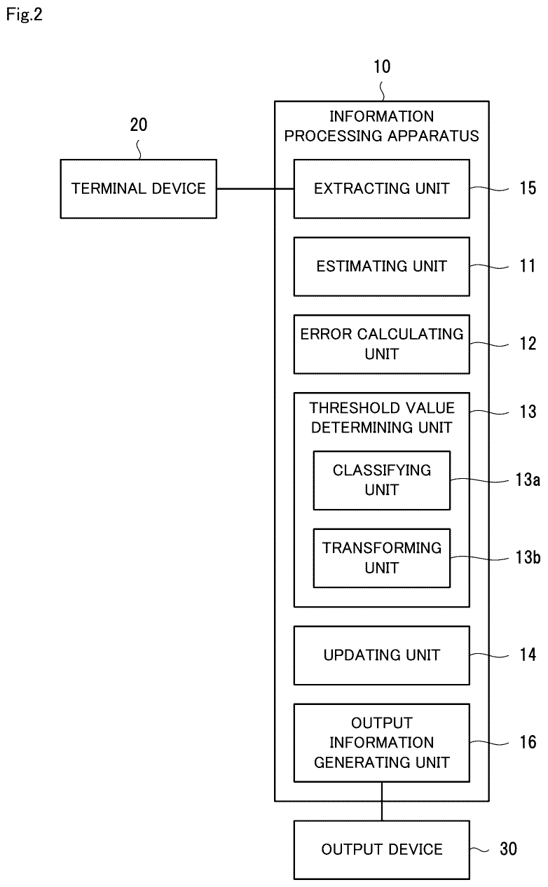

Next, the configuration of the information processing apparatus 10 of the example embodiment will be more specifically described using FIG. 2. FIG. 2 is a diagram for describing an example of a system including the information processing apparatus. The system includes the information processing apparatus 10, a terminal device (or storage device) 20, and an output device 30. Note that the information processing apparatus 10, the storage device 20, and the output device 30 are electrically connected by a communication network.

The information processing apparatus 10 is a CPU (Central Processing Unit), a programmable device such as an FPGA (Field-Programmable Gate Array), or a GPU (Graphics Processing Unit), or a circuit on which at least one of the devices is mounted, or an information processing apparatus such as a server computer, a personal computer, or a mobile terminal.

The terminal device 20 is an information processing apparatus such as a personal computer or a mobile terminal on which a CPU or an FPGA, or both of them are mounted, for example. The terminal device 20 may also be a storage device. The storage device is a database, a server computer, a circuit including a memory, or the like. In the example in FIG. 2, the storage device is provided outside the information processing apparatus 10, but may also be provided inside the information processing apparatus 10.

The output device 30 acquires later-described output information that has been converted into a format that can be output, and outputs images, audio and the like generated based on this output information. The output device 30 is an image display device that uses liquid crystal, organic EL (ElectroLuminescence), or a CRT (Cathode Ray Tube). Furthermore, the image display device may include an audio output device such as a speaker, and the like. Note that the output device 30 may also be a printing device such as a printer.

The network is an ordinary communication network constructed using a communication line such as the Internet, a LAN (Local Area Network), a dedicated line, a telephone line, an intranet, a mobile communication network, Bluetooth (registered trademark), or WiFi (Wireless Fidelity) (registered trademark), for example.

As shown in FIG. 2, the information processing apparatus 10 in the example embodiment includes an extracting unit 15, the estimating unit 11, the error calculating unit 12, the threshold value determining unit 13 (classifying unit 13a, transforming unit 13b), the updating unit 14, and an output information generating unit 16.

The extracting unit 15 extracts sample points from a plurality of data points. Specifically, the extracting unit 15 first acquires the plurality of data points and information needed to estimate parameters from the terminal device 20 or the like. Next, the extracting unit 15 extracts sample points from the plurality of data points by performing extraction processing that is set in advance. In the extraction processing, sample points are extracted at random, for example.

The information needed to estimate parameters are a minimum number of samples, an initial value of the best number of inliers, an upper limit value of the number of repetitions, and the like.

The minimum number of samples is two points if the parameters to be estimated are for a straight line, and is three points if the parameters to be estimated are for a plane, for example. The initial value of the best number of inliers is a number that is larger than the minimum number of samples. The reason is that the tentative geometric parameters completely fit the sample points, and the errors thereof are theoretically zero.

The upper limit value of the number of repetitions is an upper limit value of the number of repetitions of a series of processing that is executed by the extracting unit 15, the estimating unit 11, the error calculating unit 12, the threshold value determining unit 13 (classifying unit 13a, transforming unit 13b), and the updating unit 14.

The estimating unit 11 estimates the tentative geometric parameters that fit the sample points using the extracted sample points. Specifically, the estimating unit 11 estimates the tentative geometric parameters (tentative model) that fit the sample points extracted at random using minimal solution, or a least squares method, for example.

The error calculating unit 12 calculates errors between the plurality of data points and the tentative geometric parameters. Specifically, the error calculating unit 12 first acquires the estimated tentative geometric parameters from the estimating unit 11. Next, the error calculating unit 12 calculates errors (geometric errors or algebraic distances) of the plurality of data points relative to the tentative geometric parameters.

For example, when the estimated tentative geometric parameters (tentative model) are of an ellipse, the error can be defined as a geometric error or an algebraic distance. The user may also select the error according to the calculation cost or the mode of implementation. For example, the geometric distance of an ellipse is defined by a fourth order equation for each sample point, and therefore the calculation cost is large. On the other hand, the algebraic distance is defined by an inner product of five-dimensional vectors, and therefore the calculation cost is small. Therefore, in an application in which speed is prioritized relative to accuracy, implementation using the algebraic distance is suitable.

The threshold value determining unit 13 calculates a boundary value (class identification boundary value) for classifying the logarithmic space of the calculated errors into two or more classes, and determines the threshold value by transforming the calculated boundary value.

Specifically, the classifying unit 13a of the threshold value determining unit 13 first acquires the calculated errors from the error calculating unit 12. Next, the classifying unit 13a of the threshold value determining unit 13 calculates logarithms of the respective errors, and calculates a boundary value by classifying the logarithmic error distribution into classes. Next, the transforming unit 13b of the threshold value determining unit 13 transforms the boundary value in the logarithmic error space into a value in the original error distribution, and sets the transformed value as the threshold value.

The classification into classes is performed using a K-means method, an EM (Expectation Maximization) algorithm, linear discriminant analysis, logistics recurrence, or the like.

When the number of inliers for which the calculated errors are less than or equal to the calculated threshold value has increased from the current best number of inliers, the updating unit 14 updates the current best geometric parameters and the current best number of inliers with the tentative geometric parameters and the number of counted inliers (number of inliers), respectively.

Specifically, the updating unit 14 first counts the number of inliers for which the calculated errors are less than or equal to the threshold value. Next, if the number of inliers is greater than the current best number of inliers, the updating unit 14 updates the current tentative geometric parameters and the current best number of inliers with the geometric parameters and the number of counted inliers, respectively.

The information processing apparatus 10 repeats the series of processing executed by the estimating unit 11, the error calculating unit 12, the threshold value determining unit 13, and the updating unit 14 until the number of repetitions reaches the upper limit value thereof. Next, when the upper limit value is reached, the information processing apparatus 10 outputs the best parameters and ends the operation.

The output information generating unit 16 generates output information to be displayed in the output device 30 by combining one or more of the plurality of data points, sample points, inliers, outliers, threshold value, geometric parameters, and number of inliers. Thereafter, the output information generating unit 16 outputs the output information to the output device 30.

### [Apparatus Operations]

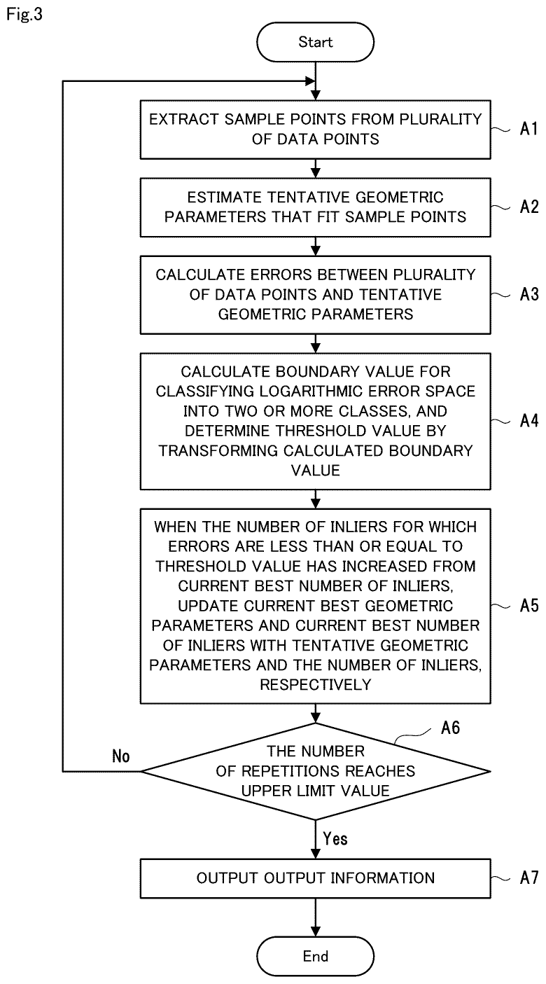

Next, operations of the information processing apparatus in the example embodiment will be described using FIG. 3. FIG. 3 is a diagram for describing an example of the operations of the information processing apparatus. In the following description, the diagrams will be referred to as appropriate. In the example embodiment, an information processing method is implemented by operating the information processing apparatus. Therefore, the following description of the operations of the information processing apparatus replaces the description of the information processing method.

As shown in FIG. 3, the extracting unit 15 extracts sample points from a plurality of data points (step A1). Specifically, in step A1, the extracting unit 15 first acquires the plurality of data points and information needed to estimate parameters from the terminal device 20 or the like. Next, the extracting unit 15 extracts the sample points at random from the plurality of data points.

Next, the estimating unit 11 estimates tentative geometric parameters that fit the sample points using the extracted sample points (step A2). Specifically, in step A2, the estimating unit 11 estimates the tentative geometric parameters (tentative model) that fit the sample points extracted at random using a least squares method or the like.

Next, the error calculating unit 12 calculates errors between the plurality of data points and the tentative geometric parameters (step A3). Specifically, in step A3, the error calculating unit 12 first acquires the estimated tentative geometric parameters from the estimating unit 11. Next, in step A3, the error calculating unit 12 calculates errors (geometric errors or algebraic distances) of the plurality of data points relative to the tentative geometric parameters.

Next, the threshold value determining unit 13 calculates a boundary value (class identification boundary value) for classifying the logarithmic space of the calculated errors into two or more classes, and determines the threshold value by transforming the calculated boundary value (step A4).

Specifically, in step A4, the classifying unit 13a of the threshold value determining unit 13 first acquires the calculated errors from the error calculating unit 12. Next, in step A4, the classifying unit 13a of the threshold value determining unit 13 calculates logarithms of the respective errors, and calculates the boundary value by classifying the logarithmic error distribution into classes. Next, in step A4, the transforming unit 13b of the threshold value determining unit 13 transforms the boundary value in the logarithmic error space into a value in the original error distribution, and sets the transformed value as the threshold value.

Next, when the number of inliers for which the calculated errors are less than or equal to the calculated threshold value (number of inliers) has increased from the current best number of inliers, the updating unit 14 updates the current best geometric parameters and the current best number of inliers with the tentative geometric parameters and the number of inliers, respectively (step A5).

Specifically, in step A5, the updating unit 14 first counts the number of inliers for which the calculated errors are less than or equal to the threshold value. Next, in step A5, if the number of inliers is greater than the current best number of inliers, the updating unit 14 updates the current tentative geometric parameters and the current best number of inliers with the geometric parameters and the number of inliers, respectively.

Next, the information processing apparatus 10 repeats the processing in steps A1 to A5 until the number of repetitions reaches the upper limit value thereof (step A6). Specifically, if the number of repetitions is not the upper limit value (step A6: No), the processing is shifted to step A1. Also, if the number of repetitions is the upper limit value (step A6: Yes), the processing is shifted to step A1.

Next, the output information generating unit 16 generates output information to be displayed in the output device 30 by combining one or more of the plurality of data points, sample points, inliers, outliers, threshold value, geometric parameters, and number of inliers. Thereafter, the output information generating unit 16 outputs the output information to the output device 30 (step A7).

### Working Examples

Specific examples of the example embodiment will be described. In this working example, the geometric parameters to be estimated are for two-dimensional straight line Θ=[a, b, c], i^{th} data point is pᵢ=[xᵢ, yᵢ], the error of the i^{th} data point relative to the straight line Θ is εᵢ (xᵢ; Θ)=|a×xᵢ+b×yᵢ+c|/sqrt(a²+b²).

Also, the tentative geometric parameters are represented as Θₜₑₘₚ, the best parameters are represented as Θ_{best}, the number of inliers is represented as Nₜₑₘₚ, the best number of inliers is represented as N_{best}, threshold value is represented as λ, and the upper limit value of the number of repetitions is represented as Iₘₐₓ, As a result of being a straight line, the minimum number of samples is s=2. Also, the initial value of the best number of inliers is set as N_{best}=s+1=3. AK-means method is used for two-class classification.

The operations in this working example will be described.

First, in step A2, the estimating unit 11 selects two sample points xⱼ and xₖ from a plurality of data points at random, and calculates a straight line Θₜₑₘₚ that connects xⱼ and xₖ.

Next, in step A3, the error calculating unit 12 calculates errors εᵢ between the plurality of data points and the tentative geometric parameters.

Next, in step A4, the threshold value determining unit 13 calculates logarithms of the respective errors, and classifies the logarithmic errors log (|εᵢ|) into two classes by applying a K-means method thereon. Then, the threshold value determining unit 13 transforms an identification boundary value in the logarithmic error space into a value in the original error distribution εᵢ, and determines the transformed value as the threshold value λ.

Next, in step A5, the updating unit 14 determines data points pᵢ for which εᵢ<λ as inliers, and the total number thereof is set as the number of inliers Nₜₑₘₚ. Then, the updating unit 14 performs update such that Θ_{best}←Θₜₑₘₚ and NₜₑₘₚΘN_{best}, if Nₜₑₘₚ>N_{best}.

Next, the information processing apparatus 10 determines whether the number of execution (number of repetitions) of processing in steps A1 to A5 has reached the upper limit value Iₘₐₓ. If the upper limit value has not been reached, the processing in steps A1 to A5 is repeated again.

In contrast, if the number of repetitions has reached the upper limit value, the output information generating unit 16 generates output information to be displayed in the output device 30 by combining one or more of the plurality of data points, sample points, inliers, outliers, threshold value λ, geometric parameters (Θₜₑₘₚ, Θ_{best}), and number of inliers (Nₜₑₘₚ, N_{best}). Thereafter, the output information generating unit 16 outputs the output information to the output device 30.

### Effects of Example Embodiment

As described above, according to the example embodiment, it is possible to automatically determine the threshold value for separating between outliers and inliers, when estimating parameters that fit a plurality of data points using RANSAC. As a result, separation between outliers and inliers can be performed at high accuracy, and the parameters that fit the inliers can be estimated at high accuracy.

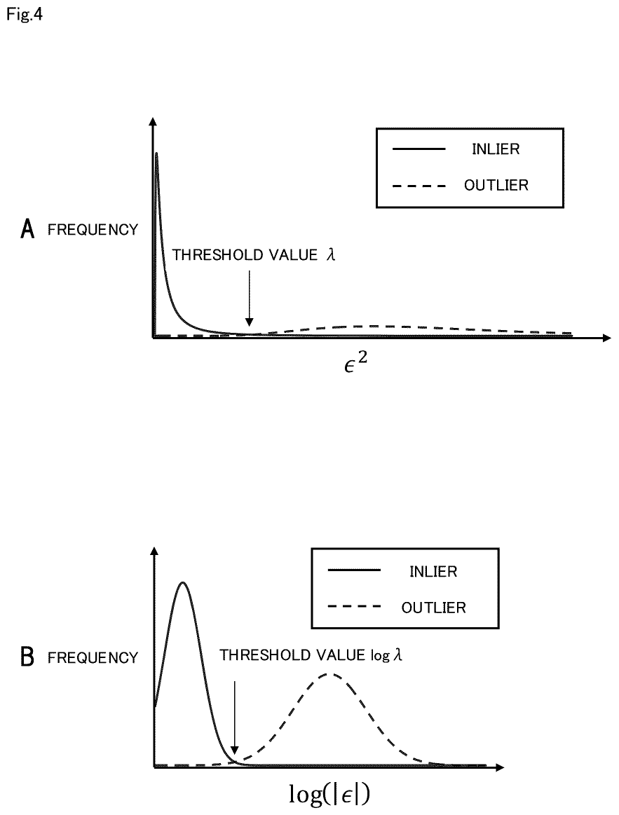

FIG. 4 is a diagram for describing the effects. FIG. 4 shows histograms (frequency values) of the squared errors εᵢ² and logarithmic errors log (|εᵢ|) of the data points relative to the best parameters Θ_{best}. First, the histogram regarding the squared errors will be described.

In A in FIG. 4, the frequency of inliers are concentrated on a left side (region where εᵢ<λ) where the error is small. On the other hand, the outliers are widely distributed in a region where εᵢ>λ. This is because the distribution of outliers is not limited and the outliers may take various values. In actuality, the optimal threshold value λ is not known in advance, and therefore it is not obvious whether a certain data point is an inlier or an outlier.

Therefore, when the histogram of squared errors is described, a distribution in which a line indicating the inliers and a dotted line indicating the outliers are added appears, as shown in A in FIG. 4. The distribution of outliers is a so-called long tail distribution in which the tail is extremely long, and the peak value thereof is not obvious. Therefore, it is not easy to separate the distribution in which inliers and outliers are added into two classes, and obtain a threshold value λ that is the boundary between the two classes.

Next, when logarithm is applied to the distribution in which two distributions are added, and the value range is narrowed down, the histogram as shown in B in FIG. 4 is obtained. As a result of the value range being narrowed down, the inliers and the outliers are distributed as clusters having clear peaks respectively. Therefore, by using any class identifier, a logarithmic threshold value (log λ) can be obtained as the identification boundary. In B in FIG. 4, the inliers and outliers are each depicted as following a normal distribution, for the sake of description, but the distribution is not necessarily a normal distribution. It is sufficient if separation between inliers and outliers can be achieved, and the distributions need not be approximated by some distribution function. Therefore, various class classifiers can be used.

The observation described above is regarding a histogram with respect to an unknown best parameters Θ_{best}, and the effects of the example embodiment can be realized by searching Θ_{best} at which N_{best} is largest by repeating the processing in steps A1 to A5.

### [Modifications]

The present example embodiment is not limited to the examples described above. In the present example embodiment, various changes that could be understood by a person skilled in the art could be applied to the examples described above. For example, the present example embodiment can also be implemented by the modes illustrated in the following modification.

### (Modification 1)

The example embodiment can be applied to various derivative methods of RANSAC, and is not limited to the original RANSAC. For example, the example embodiment can be combined with LO-RANSAC described in Non-Patent Document 1.

### (Modification 2)

The threshold value determining unit 13 determines the tentative threshold value from statistical amounts by fitting a predetermined probability distribution to the classified classes.

The method of determining the threshold value is not limited to the example embodiment described above. For example, the determination of inliers and outliers can become uncertain near the boundary between clusters, and therefore a margin may be provided by multiplying the boundary value by a value smaller than one (such as 0.9 or 0.8).

Assume also that the original error distribution (ei) of data points that were determined as inliers is a normal distribution, for example, and the threshold value is determined to be μ+βσ using an average value μ and a standard deviation σ of the errors εᵢ that are smaller than the threshold value λ. β is a constant for determining a confidence interval of a normal distribution, and if β=2, for example, about 95 [%] of the data points determined as inliers are included.

In order to also prevent the threshold value λ from becoming too small or too large, when the minimum threshold value λₘᵢₙ or maximum threshold value λₘₐₓ of the threshold value can be estimated in advance such as in a case where the error unit is a pixel value, the estimated threshold value λ may be adopted only if λₘᵢₙ<λ<λₘₐₓ. The maximum and minimum threshold values may be λₘᵢₙ=0.5 [pixels] and λₘₐₓ=20 [pixels] in the case of a pixel value, and may also be λₘᵢₙ=1 [degree] and λₘₐₓ=10 [degrees] in the case of an angle formed by two vectors.

### (Modification 3)

If the calculated threshold value λ is in a range between the predetermined minimum threshold value λₘᵢₙ and the predetermined maximum threshold value Amax, the threshold value determining unit 13 outputs the threshold value λ, and if the calculated threshold value λ is out of the range, the threshold value determining unit 13 outputs whichever of the minimum threshold value λₘᵢₙ or the maximum threshold value λₘₐₓ is closer to the calculated threshold value λ. If the number of inliers whose errors are smaller than the previous maximum threshold value or a threshold value determined in advance is larger than the minimum number of samples, the threshold value determining unit 13 classifies classes.

For example, only when tentative inliers have been found using a maximum threshold value λₘₐₓ determined in advance, the threshold value determining unit 13 may execute application of a class classifier to logarithmic errors log (|εᵢ|). Then, the threshold value determining unit 13 further extracts, from the tentative inliers, the minimum number of samples, or data points for executing a least squares method at random, and again calculates the tentative geometric parameters. Thereafter, the threshold value determining unit 13 may calculate the tentative threshold value by classifying logarithmic errors of the plurality of data points into classes.

As disclosed in Non-Patent Document 1, the probability that the sample points extracted at random are all inliers is not high. In Modification 3, classification into classes need not be executed (class classifier need not be operated) every time, and therefore the amount of calculation can be reduced, and the apparatus operation can be sped up.

### (Modification 4)

The upper limit value Iₘₐₓ of the number of repetitions may not be a fixed value. When the best number of inliers is updated in step A5, the upper limit value Iₘₐₓ may be changed based on the ratio of inliers in the plurality of data points.

### (Modification 5)

In Modification 5, the error calculating unit 12 calculates, using a plurality of error functions, errors between a plurality of data points and tentative geometric parameters for each error function. The threshold value determining unit 13 also determines a threshold value for each set of the calculated errors. Thereafter, the updating unit 14 counts the number of inliers for each of the threshold values, and performs updating when all or at least one of the numbers of inliers counted increases.

As described above, the error function used in the error calculating unit 12 is not limited to one error function. For example, an algebraic distance and a geometric error are used together, and errors may be calculated with respect to each of them. In this case, the threshold value determining unit 13 determines threshold values for the respective sets of errors. The updating unit 14 may determine data points for which all, at least one, or half or more of the errors are less than or equal to the corresponding threshold values as tentative inliers.

When a plurality of algebraic distances or geometric errors can also be defined, these distances or errors may be used together. For example, in planar projective transformation of images, a plurality of geometric errors (one-sided conversion error, symmetrical conversion error, reprojection error) are present.

### (Modification 6)

The class classifier used in the threshold value determining unit 13 is not limited to the two-class classifier. It is possible that the distribution of outliers is a distribution in which a plurality of peaks are present, and therefore a multi-class classifier may also be used, for example.

### [Program]

The program according to the example embodiment and the modifications may be a program that causes a computer to execute steps A1 to A7 shown in FIG. 3. By installing this program in a computer and executing the program, the information processing apparatus and the information processing method according to the example embodiment can be realized. Further, the processor of the computer performs processing to function as the extracting unit 15, the estimating unit 11, the error calculating unit 12, the threshold value determining unit 13 (classifying unit 13a, transforming unit 13b), the updating unit 14, and the output information generating unit 16.

Also, the program according to the example embodiment and the modifications may be executed by a computer system constructed by a plurality of computers. In this case, for example, each computer may function as any of the extracting unit 15, the estimating unit 11, the error calculating unit 12, the threshold value determining unit 13 (classifying unit 13a, transforming unit 13b), the updating unit 14, and the output information generating unit 16.

### [Physical Configuration]

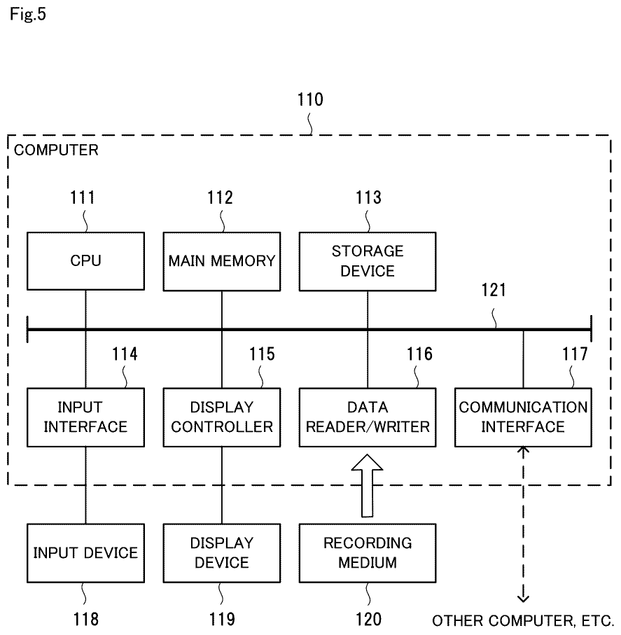

Here, a computer that realizes an information processing apparatus by executing the program according to the example embodiment and the modifications will be described with reference to FIG. 5. FIG. 5 is a diagram for describing an example of a computer that realizes the information processing apparatus in the example embodiment and the modifications.

As shown in FIG. 5, a computer 110 includes a CPU 111, a main memory 112, a storage device 113, an input interface 114, a display controller 115, a data reader/writer 116, and a communication interface 117. These units are connected via bus 121 so as to be able to perform data communication with each other. Note that the computer 110 may include a GPU or a FPGA in addition to the CPU111 or instead of the CPU111.

The CPU111 loads a program (codes) according to the example embodiments stored in the storage device 113 to the main memory 112, and executes them in a predetermined order to perform various kinds of calculations. The main memory 112 is typically a volatile storage device such as a DRAM (Dynamic Random Access Memory).

Also, the program according to the example embodiments are provided in the state of being stored in a computer-readable recording medium 120. Note that the program according to the first and second example embodiments and the first and second working examples may be distributed on the Internet that is connected via the communication interface 117.

Specific examples of the storage device 113 include a hard disk drive, and a semiconductor storage device such as a flash memory. The input interface 114 mediates data transmission between the CPU 111 and the input device 118 such as a keyboard or a mouse. The display controller 115 is connected to a display device 119, and controls the display of the display device 119.

The data reader/writer 116 mediates data transmission between the CPU 111 and the recording medium 120, and reads out the program from the recording medium 120 and writes the results of processing performed in the computer 110 to the recording medium 120. The communication interface 117 mediates data transmission between the CPU 111 and another computer.

Specific examples of the recording medium 120 include general-purpose semiconductor storage devices such as a CF (Compact Flash (registered trademark)) and a SD (Secure Digital), a magnetic recording medium such as a flexible disk, and an optical recording medium such as a CD-ROM (Compact Disk Read Only Memory).

The information processing apparatus 10 according to the example embodiment can also be achieved using hardware corresponding to the components, instead of a computer in which a program is installed. Furthermore, a part of the information processing apparatus 10 may be realized by a program and the remaining part may be realized by hardware. In the example embodiments, the computer is not limited to the computer shown in FIG. 5.

### [Supplementary Notes]

Furthermore, the following supplementary notes are disclosed regarding the example embodiments described above. Some portion or all of the example embodiments described above can be realized according to (supplementary note 1) to (supplementary note 21) described below, but the below description does not limit the present invention.

### (Supplementary Note 1)

An information processing apparatus comprising:
an estimating unit configured to estimate, using sample points extracted from a plurality of data points, tentative geometric parameters that fit the sample points;
an error calculating unit configured to calculate errors between the plurality of data points and the tentative geometric parameters;
a threshold value determining unit configured to calculate a boundary value for classifying a logarithmic space of the calculated errors into two or more classes, and determine a threshold value by transforming the calculated boundary value; and
an updating unit configured to count a number of inliers for which the calculated errors are less than or equal to the calculated threshold value, and when the number of inliers counted increases, update current best geometric parameters and a current best number of inliers with the tentative geometric parameters and the number of inliers, respectively.

### (Supplementary Note 2)

The information processing apparatus according to Supplementary note 1,
wherein the information processing apparatus repeats a series of processing to be executed by the estimating unit, the error calculating unit, the threshold value determining unit, and the updating unit until the number of repetitions reaches a preset upper limit value.

### (Supplementary Note 3)

The information processing apparatus according to Supplementary note 2,
wherein the threshold value determining unit determines the threshold value from statistical amounts by fitting a predetermined probability distribution to the classified classes.

### (Supplementary Note 4)

The information processing apparatus according to Supplementary note 3,
wherein, if the calculated threshold value is in a range between a predetermined minimum threshold value and a predetermined maximum threshold value, the threshold value determining unit outputs the threshold value, and if the calculated threshold value is out of the range, the threshold value determining unit outputs whichever of the minimum threshold value or the maximum threshold value is closer to the calculated threshold value.

### (Supplementary Note 5)

The information processing apparatus according to Supplementary note 4,
wherein the threshold value determining unit classifies the classes when the number of inliers whose errors are smaller than a previous maximum threshold value or a predetermined threshold value is larger than a minimum number of samples.

### (Supplementary Note 6)

The information processing apparatus according to Supplementary note 2,
wherein the error calculating unit calculates, using a plurality of error functions, the errors between the plurality of data points and the tentative geometric parameters for each error function,
the threshold value determining unit determines the threshold value for each set of the calculated errors, and
the updating unit counts the number of inliers for each of the threshold values, and performs updating when all, at least one, or half or more of the numbers of inliers counted increase.

### (Supplementary Note 7)

The information processing apparatus according to Supplementary note 2,
wherein when the updating unit has updated the best geometric parameters, the upper limit value of the number of repetitions is changed based on the ratio of inliers in the plurality of data points.

### (Supplementary Note 8)

An information processing method executed by a computer, comprising:
an estimating process of estimating, using sample points extracted from a plurality of data points, tentative geometric parameters that fit the sample points;
calculating errors between the plurality of data points and the tentative geometric parameters;
a threshold value determining process of calculating a boundary value for classifying a logarithmic space of the calculated errors into two or more classes, and determining a threshold value by transforming the calculated boundary value; and
an updating process of counting a number of inliers for which the calculated errors are less than or equal to the calculated threshold value, and when the number of inliers counted increases, updating current best geometric parameters and a current best number of inliers with the tentative geometric parameters and the number of inliers, respectively.

### (Supplementary Note 9)

The information processing method according to Supplementary note 8,
wherein the information processing apparatus repeats a series of processing to be executed by the estimating process, the error calculating process, the threshold value determining process, and the updating process until the number of repetitions reaches a preset upper limit value.

### (Supplementary Note 10)

The information processing method according to Supplementary note 9,
wherein the threshold value determining process determines the threshold value from statistical amounts by fitting a predetermined probability distribution to the classified classes.

### (Supplementary Note 11)

The information processing method according to Supplementary note 10,
wherein, if the calculated threshold value is in a range between a predetermined minimum threshold value and a predetermined maximum threshold value, the threshold value determining process outputs the threshold value, and if the calculated threshold value is out of the range, the threshold value determining process outputs whichever of the minimum threshold value or the maximum threshold value is closer to the calculated threshold value.

### (Supplementary Note 12)

The information processing method according to Supplementary note 11,
wherein the threshold value determining process classifies the classes when the number of inliers whose errors are smaller than a previous maximum threshold value or a predetermined threshold value is larger than a minimum number of samples.

### (Supplementary Note 13)

The information processing method according to Supplementary note 9,
wherein the error calculating process calculates, using a plurality of error functions, the errors between the plurality of data points and the tentative geometric parameters for each error function,
the threshold value determining process determines the threshold value for each set of the calculated errors, and
the updating process counts the number of inliers for each of the threshold values, and performs updating when all, at least one, or half or more of the numbers of inliers counted increase.

### (Supplementary Note 14)

The information processing method according to Supplementary note 9,
wherein when the updating process has updated the best geometric parameters, the upper limit value of the number of repetitions is changed based on the ratio of inliers in the plurality of data points.

### (Supplementary Note 15)

A non-transitory computer-readable recording medium on which a program including instructions is recorded, the instructions causing a computer to carry out:
an estimating process of estimating, using sample points extracted from a plurality of data points, tentative geometric parameters that fit the sample points;
calculating errors between the plurality of data points and the tentative geometric parameters;
a threshold value determining process of calculating a boundary value for classifying a logarithmic space of the calculated errors into two or more classes, and determining a threshold value by transforming the calculated boundary value; and
an updating process of counting a number of inliers for which the calculated errors are less than or equal to the calculated threshold value, and when the number of inliers counted increases, updating current best geometric parameters and a current best number of inliers with the tentative geometric parameters and the number of inliers, respectively.

### (Supplementary Note 16)

The non-transitory computer-readable recording medium according to Supplementary note 15,
wherein the information processing apparatus repeats a series of processing to be executed by the estimating process, the error calculating process, the threshold value determining process, and the updating process until the number of repetitions reaches a preset upper limit value.

### (Supplementary Note 17)

The non-transitory computer-readable recording medium according to Supplementary note 16,
wherein the threshold value determining process determines the threshold value from statistical amounts by fitting a predetermined probability distribution to the classified classes.

### (Supplementary Note 18)

The non-transitory computer-readable recording medium according to Supplementary note 17,
wherein, if the calculated threshold value is in a range between a predetermined minimum threshold value and a predetermined maximum threshold value, the threshold value determining process outputs the threshold value, and if the calculated threshold value is out of the range, the threshold value determining process outputs whichever of the minimum threshold value or the maximum threshold value is closer to the calculated threshold value.

### (Supplementary Note 19)

The non-transitory computer-readable recording medium according to Supplementary note 18,
wherein the threshold value determining process classifies the classes when the number of inliers whose errors are smaller than a previous maximum threshold value or a predetermined threshold value is larger than a minimum number of samples.

### (Supplementary Note 20)

The non-transitory computer-readable recording medium according to Supplementary note 16,
wherein the error calculating process calculates, using a plurality of error functions, the errors between the plurality of data points and the tentative geometric parameters for each error function,
the threshold value determining process determines the threshold value for each set of the calculated errors, and
the updating process counts the number of inliers for each of the threshold values, and performs updating when all, at least one, or half or more of the numbers of inliers counted increase.

### (Supplementary Note 21)

The non-transitory computer-readable recording medium according to Supplementary note 16,
wherein when the updating process has updated the best geometric parameters, the upper limit value of the number of repetitions is changed based on the ratio of inliers in the plurality of data points.

Although the present invention of this application has been described with reference to exemplary embodiments, the present invention of this application is not limited to the above exemplary embodiments. Within the scope of the present invention of this application, various changes that can be understood by those skilled in the art can be made to the configuration and details of the present invention of this application.

### INDUSTRIAL APPLICABILITY

According to the description described above, the threshold value for separating between outliers and inliers, in RANSAC, can be determined. Also, it is useful in a field where the geometric parameters need to be estimated.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An information processing apparatus comprising:
at least one memory storing instructions; and
at least one processor configured to execute the instructions to:
estimate, using sample points extracted from a plurality of data points, tentative geometric parameters that fit the sample points;
calculate errors between the plurality of data points and the tentative geometric parameters;
calculate a boundary value for classifying a logarithmic space of the calculated errors into two or more classes, and determine a threshold value by transforming the calculated boundary value; and
count a number of inliers for which the calculated errors are less than or equal to the calculated threshold value, and when the number of inliers counted increases, update current best geometric parameters and a current best number of inliers with the tentative geometric parameters and the number of inliers, respectively.

2. The information processing apparatus according to claim 1,
wherein the one or more processors further:
repeats a series of processing to be executed by the process of estimating the tentative geometric parameters, the process of calculating the errors, the process of determining the threshold value, and the process of updating the tentative geometric parameters and the number of inliers until the number of repetitions reaches a preset upper limit value.

3. The information processing apparatus according to claim 2,
wherein the one or more processors further:
determines the threshold value from statistical amounts by fitting a predetermined probability distribution to the classified classes.

4. The information processing apparatus according to claim 3,
wherein the one or more processors further:
if the calculated threshold value is in a range between a predetermined minimum threshold value and a predetermined maximum threshold value, the threshold value determining unit outputs the threshold value, and if the calculated threshold value is out of the range, the threshold value determining unit outputs whichever of the minimum threshold value or the maximum threshold value is closer to the calculated threshold value.

5. The information processing apparatus according to claim 4,
wherein the one or more processors further:
classifies the classes when the number of inliers whose errors are smaller than a previous maximum threshold value or a predetermined threshold value is larger than a minimum number of samples.

6. The information processing apparatus according to claim 2,
wherein the one or more processors further:
calculates, using a plurality of error functions, the errors between the plurality of data points and the tentative geometric parameters for each error function,
determines the threshold value for each set of the calculated errors, and
counts the number of inliers for each of the threshold values, and performs updating when all, at least one, or half or more of the numbers of inliers counted increase.

7. The information processing apparatus according to claim 2,
wherein the one or more processors further:
when the updating unit has updated the best geometric parameters, the upper limit value of the number of repetitions is changed based on the ratio of inliers in the plurality of data points.

8. An information processing method comprising:
estimating, using sample points extracted from a plurality of data points, tentative geometric parameters that fit the sample points;
calculating errors between the plurality of data points and the tentative geometric parameters;
calculating a boundary value for classifying a logarithmic space of the calculated errors into two or more classes, and determining a threshold value by transforming the calculated boundary value; and
counting a number of inliers for which the calculated errors are less than or equal to the calculated threshold value, and when the number of inliers counted increases, updating current best geometric parameters and a current best number of inliers with the tentative geometric parameters and the number of inliers, respectively.

9. A non-transitory computer-readable recording medium on which a program including instructions is recorded, the instructions causing a computer to carry out:
estimating, using sample points extracted from a plurality of data points, tentative geometric parameters that fit the sample points;
calculating errors between the plurality of data points and the tentative geometric parameters;
calculating a boundary value for classifying a logarithmic space of the calculated errors into two or more classes, and determining a threshold value by transforming the calculated boundary value; and
counting a number of inliers for which the calculated errors are less than or equal to the calculated threshold value, and when the number of inliers counted increases, updating current best geometric parameters and a current best number of inliers with the tentative geometric parameters and the number of inliers, respectively.
